(19) United States
(12) Patent Application Publication
(10) Pub. No.: US 2022/0186818 A1
(43) Pub. Date: Jun. 16, 2022

(54) TORQUE CONVERTER WITH CORIOLIS LEAF SPRING

(71) Applicant: Schaeffler Technologies AG & Co. KG, Herzogenaurach (DE)

(72) Inventors: Victor Norwich, Wooster, OH (US); Felipe de Lima Zocca, Wooster, OH (US)

(73) Assignee: Schaeffler Technologies AG & Co. KG, Herzogenaurach (DE)

(21) Appl. No.: 17/123,187

(22) Filed: Dec. 16, 2020

(51) Int. Cl. F16H 45/02

(52) U.S. Cl. CPC F16H 45/02; F16H 2045/0226

(57) ABSTRACT

A torque converter, including: a cover arranged to receive torque; an impeller including an impeller shell connected to the cover and at least one impeller blade fixedly connected to the impeller shell; a turbine including a turbine shell and at least one turbine blade fixedly connected to the turbine shell; lock-up clutch including a piston plate; an output element arranged to non-rotatably connect to a transmission input shaft; and a leaf spring including a ring portion, a tab extending radially inwardly from the ring portion, and a plurality of resilient sections extending from the ring portion and non-rotatably connected to the cover and to the piston plate.

### TECHNICAL FIELD

The present disclosure relates to a torque converter with leaf springs to off-set coriolis forces associated with operation of a lock-up clutch of the torque converter.

### BACKGROUND

A coriolis force develops during operation of a lock-up clutch for a known torque converter. The coriolis force creates a back pressure in fluid used to operate the lock-up clutch, which can interfere with operation of the lock-up clutch.

### SUMMARY

According to aspects illustrated herein, there is provided a torque converter, including: a cover arranged to receive torque; an impeller including an impeller shell connected to the cover and at least one impeller blade fixedly connected to the impeller shell; a turbine including a turbine shell and at least one turbine blade fixedly connected to the turbine shell; lock-up clutch including a piston plate; an output element arranged to non-rotatably connect to a transmission input shaft; and a leaf spring including a ring portion, a tab extending radially inwardly from the ring portion, and a plurality of resilient sections extending from the ring portion and non-rotatably connected to the cover and to the piston plate.

According to aspects illustrated herein, there is provided a torque converter, including: a cover arranged to receive rotational torque; an impeller including an impeller shell connected to the cover and at least one impeller blade fixedly connected to the impeller shell; a turbine including a turbine shell and at least one turbine blade fixedly connected to the turbine shell; a lock-up clutch including a piston plate; an output element arranged to non-rotatably connect to a transmission input shaft; and a first leaf spring including a first ring portion, a first plurality of resilient sections non-rotatably connected to the cover and to the piston plate and located radially outward of the first ring portion, and a plurality of first tabs extending radially inwardly from the first ring portion, each first tab including a first section directly connected to the first ring portion, and a second section extending in an axial direction, parallel to an axis of rotation of the torque converter, from the first section.

According to aspects illustrated herein, there is provided a method of operating a torque converter including a cover, an impeller, a turbine including a turbine shell, a lock-up clutch including a piston plate, an output element, and a leaf spring including a ring portion, a plurality of resilient sections located radially outward of the ring portion and non-rotatably connected to the cover and to the piston plate, and a plurality of tabs extending radially inwardly from the ring portion. The method includes: receiving, with the cover, a rotational torque in a first circumferential direction; rotating, with the rotational torque, the cover, and the leaf spring in the first circumferential direction; for a clutch apply mode in which the lock-up clutch is closed, flowing pressurized fluid from a first pressure chamber formed in part by the cover, the piston plate, and the turbine shell to a second pressure chamber formed in part by the cover and the piston plate; flowing the pressurized fluid radially inwardly through the second pressure chamber to a channel of a transmission input shaft non-rotatably connected to the output element; generating, with the rotation of the cover, a coriolis force on the pressurized fluid in a portion of the second pressure chamber defined in part by the ring portion and located radially inwardly of the ring portion; urging, with the coriolis force, the pressurized fluid in the portion of the second pressure chamber in a second circumferential direction, opposite the first circumferential direction; rotating the plurality of tabs through the pressurized fluid in the portion of the second pressure chamber; and directing, with the plurality of tabs, the pressurized fluid in the second pressure chamber in the first circumferential direction.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a partial cross-sectional view of a torque converter with coriolis leaf springs;

FIG. 2 is an isometric view of a coriolis leaf spring shown in FIG. 1;

FIG. 3 is a back view of the coriolis leaf spring shown in FIG. 2;

FIG. 4 is an isometric view of the coriolis leaf springs shown in FIG. 1;

FIG. 5 is a back view of the coriolis leaf springs shown in FIG. 4;

FIG. 6 is a detail of area 6 in FIG. 1;

FIG. 7 is a detail of area 6 in FIG. 1 with an example embodiment of coriolis leaf springs; and,

FIG. 8 is a detail of area 6 in FIG. 1 with an example embodiment of coriolis leaf springs.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the present disclosure.

Unless defined otherwise, all technical and scientific terms used herein have the same meaning as commonly understood to one of ordinary skill in the art to which this disclosure belongs. It should be understood that any methods, devices, or materials similar or equivalent to those described herein can be used in the practice or testing of the disclosure.

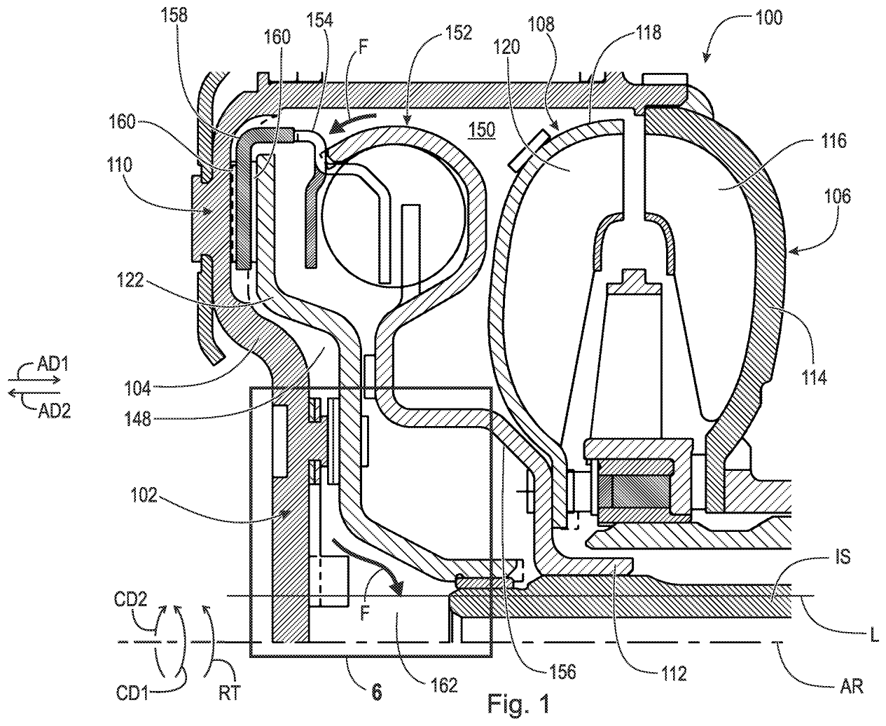

FIG. 1 is a partial cross-sectional view of torque converter 100 with coriolis leaf springs 102. Torque converter 100 includes: cover 104 arranged to receive rotational torque RT; impeller 106; turbine 108; lock-up clutch 110; and output element 112 arranged to non-rotatably connect to transmission input shaft IS. Impeller 106 includes: impeller shell 114 non-rotatably connected to cover 104; and at least one impeller blade 116 fixedly connected to impeller shell 114. Turbine 108 includes: turbine shell 118; and at least one turbine blade 120 fixedly connected to turbine shell 118. Lock-up clutch 110 includes piston plate 122. Coriolis leaf springs 102 are selectable to: urge piston plate 122 in direction AD1, parallel to axis of rotation AR of torque converter 100, with respect to cover 104; or urge piston plate 122 in direction AD2, opposite direction AD1, with respect to cover 104.

By “non-rotatably connected” components, we mean that components are connected so that whenever one of the components rotates, all the components rotate; and relative rotation between the components is precluded. Radial and/or axial movement of non-rotatably connected components with respect to each other is possible. Components connected by tabs, gears, teeth, or splines are considered as non-rotatably connected despite possible lash inherent in the connection. The input and output elements of a closed clutch are considered non-rotatably connected despite possible slip in the clutch. The input and output parts of a vibration damper, engaged with springs for the vibration damper, are not considered non-rotatably connected due to the compression and unwinding of the springs. Without a further modifier, the non-rotatable connection between or among components is assumed for rotation in any direction. However, the non-rotatable connection can be limited by use of a modifier. For example, “non-rotatably connected for rotation in circumferential direction CD1,” defines the connection for rotation only in circumferential direction CD1.

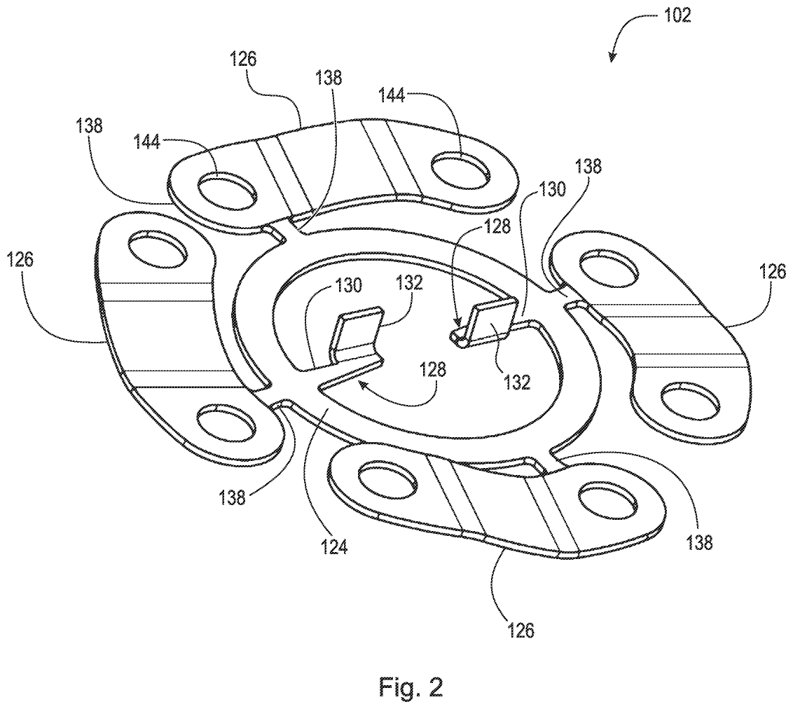

FIG. 2 is an isometric view of a coriolis leaf spring 102 shown in FIG. 1.

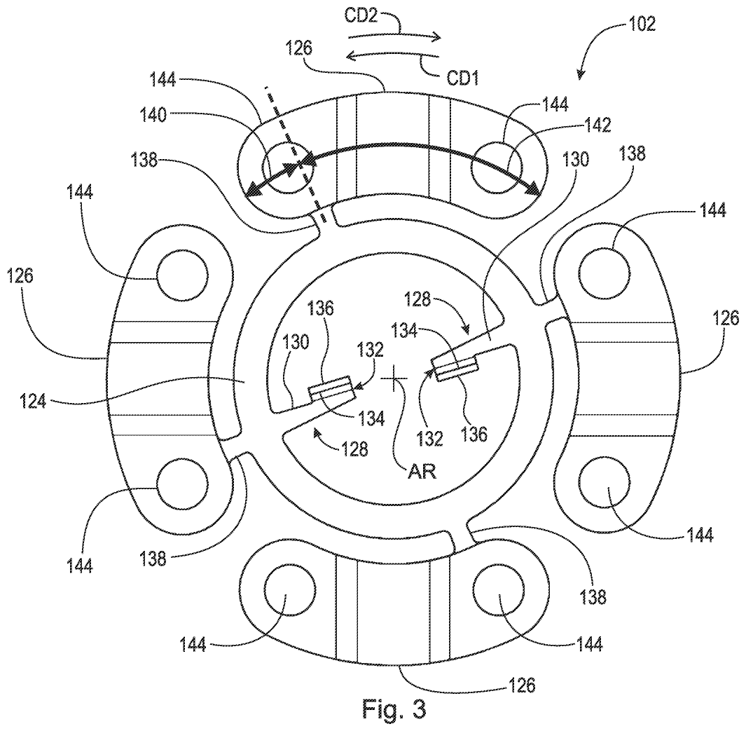

FIG. 3 is a back view of coriolis leaf spring 102 shown in FIG. 2. The following should be viewed in light of FIGS. 1 through 3. Leaf spring 102 includes ring portion 124, resilient sections 126, and tabs 128. Resilient sections 126 extend from ring portion 124. In the example of FIG. 1, leaf spring 102 is formed of a single piece of material. In the example of FIG. 1, ring portion 124 is circumferentially continuous. Tabs 128 extend radially inwardly from ring portion 124.

Each tab 128 includes section 130 and section 132. Section 130 extends directly from ring portion 124 and in the example of FIG. 1, section 132 extends in axial direction AD from section 130. Section 132 includes: surface 134 facing at least partly in circumferential direction CD1 around axis of rotation AR; and surface 136 facing at least partly in circumferential direction CD2, opposite circumferential direction CD1.

Leaf spring 102 includes connectors 138 extending radially outwardly from ring portion 124 and connecting resilient sections 126 to ring portion 124. In the example of FIG. 1, each resilient section 126 extends past connector 138 in circumferential direction CD1 and in circumferential direction CD2. In the example of FIG. 1, each resilient section 126 extends past connector 138 by distance 140 in circumferential direction CD1 and by distance 142, different from distance 140, in circumferential direction CD2. In the example of FIG. 1, distance 142 is greater than distance 140.

In the example of FIG. 1, leaf spring 102 includes two circumferentially off-set tabs 128. In the example of FIG. 1, the two tabs 128 are 180 degrees off-set. It is understood that: leaf spring 102 is not limited to two tabs 128; other numbers of tabs 128 are possible for leaf spring 102; and other spacings between tabs 128 are possible for leaf spring 102.

In the example of FIG. 1, line L is: parallel to axis of rotation AR; passes through at least a portion of a section 132; and is located radially inwardly of piston plate 122, output element 112, turbine 108, and impeller 106. In the example of FIG. 1, an entirety of a section 132 is located radially inwardly of impeller 106 and turbine 108.

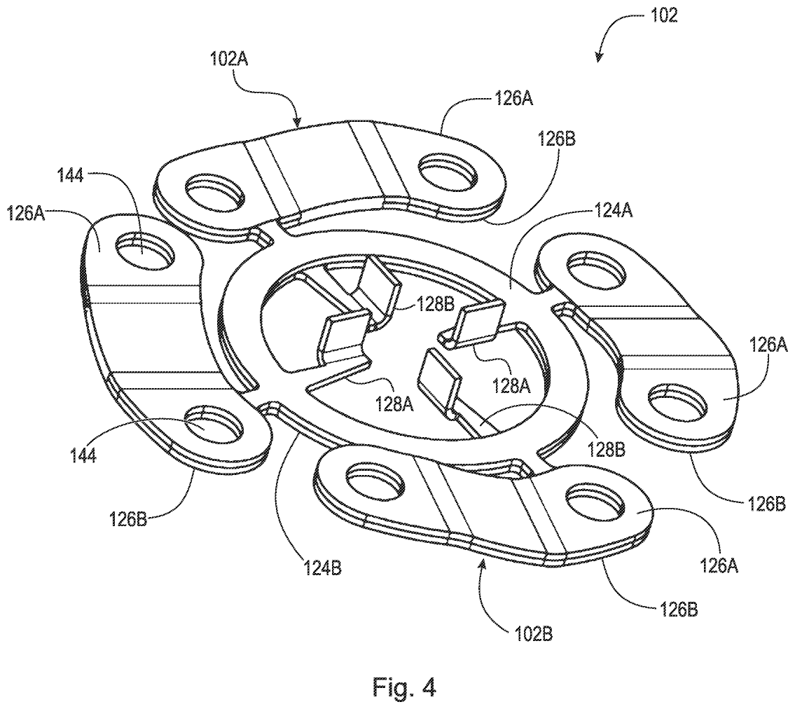

FIG. 4 is an isometric view of coriolis leaf springs 102 shown in FIG. 1.

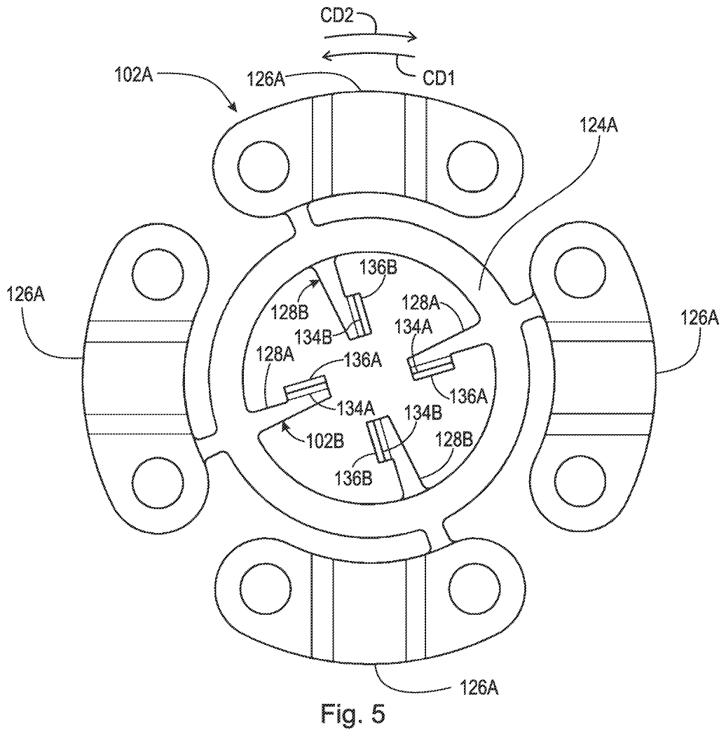

FIG. 5 is a back view of coriolis leaf springs 102 shown in FIG. 4. The following should be viewed in light of FIGS. 1 through 5. In the example of FIG. 1, torque converter 100 includes two coriolis leaf springs 102. To clarify the discussion, coriolis leaf springs 102 in FIGS. 4 and 5 are labeled as coriolis leaf spring 102A and coriolis leaf spring 102B. The discussion of coriolis leaf spring 102 in FIGS. 2 and 3 is applicable to coriolis leaf spring 102A and coriolis leaf spring 102B. To further distinguish coriolis leaf spring 102A from coriolis leaf spring 102B, in FIGS. 4 and 5: “A” has been added to the reference characters of components of coriolis leaf spring 102A; and “B” has been added to the reference characters of components coriolis leaf spring 102B. It is understood that torque converter 100 is not limited to two coriolis leaf springs 102 and that other numbers of coriolis leaf springs 102 are possible for torque converter 100.

In the example of FIG. 1: coriolis leaf spring 102A and coriolis leaf spring 102B are axially stacked; resilient sections 126A of coriolis leaf spring 102A and resilient sections 126B of coriolis leaf spring 102B axially overlap; and tabs 128A of coriolis leaf spring 102A and tabs 128B coriolis leaf spring 102B are circumferentially off set from each other. In the example of FIG. 1, tabs 128A of coriolis leaf spring 102A and tabs 128B of coriolis leaf spring 102B alternate in circumferential direction CD1. That is, tabs 128A and tabs 128B are circumferentially interleaved.

It is understood that other configurations of tabs 128A of coriolis leaf spring 102A and tabs 1288 of coriolis leaf spring 102B are possible. It is understood that coriolis leaf spring 102A and coriolis leaf spring 102B are not limited to having the same number of tabs 128 or the same circumferential orientation of tabs 128.

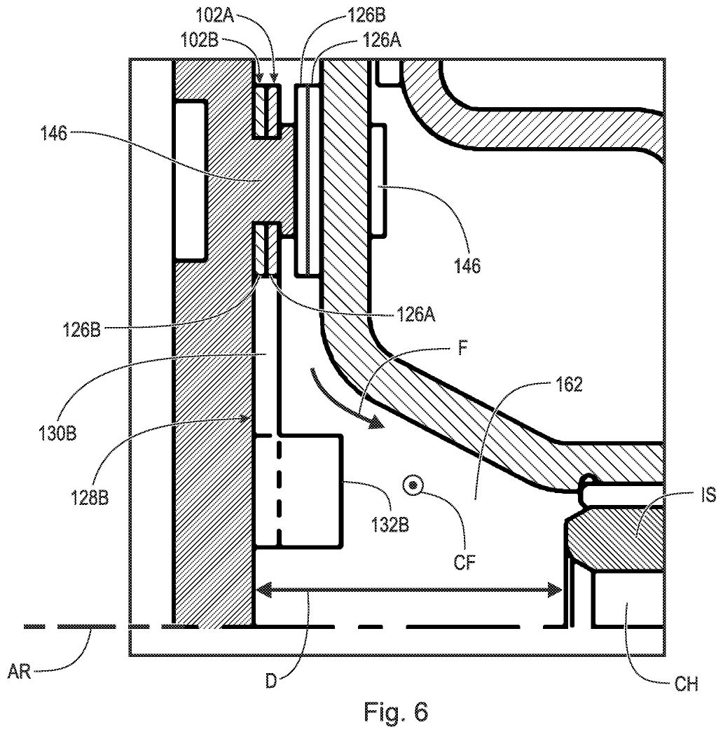

FIG. 6 is a detail of area A in FIG. 1. The following should be viewed in light of FIGS. 1 through 6. Each resilient section 126A and 126B includes openings 144. Fasteners 146 pass through openings 144 and non-rotatably connect resilient sections 126A and 126B to cover 104 and to piston plate 122. Thus, each coriolis leaf spring 102 is non-rotatably connected to cover 104 and piston plate 122.

Cover 104 and piston plate 122 define at least part of release pressure chamber 148. Cover 104, piston plate 122, and turbine shell 118 define at least part of apply pressure chamber 150. Coriolis leaf springs 102 are located in release pressure chamber 148. Fluid pressure in chambers 148 and 150 is manipulated to open and close clutch 110.

In a clutch release mode of torque converter 100: fluid pressure in chamber 148 is greater than fluid pressure in chamber 150; the differential fluid pressure between chambers 148 and 150 displaces piston plate 122 in axial direction AD1 to open clutch 110; and torque RT is transmitted from cover 104 to output element 112 via impeller 106 and turbine 108.

In a clutch apply mode of torque converter 100: fluid pressure in chamber 150 is greater than fluid pressure in chamber 148; the differential fluid pressure between chambers 148 and 150 displaces piston plate 122 in axial direction AD2, opposite direction AD1, to close clutch 110; and torque RT is transmitted from cover 104 to output element 112 via clutch 110.

In the example of FIG. 1, torque converter 100 includes torsional vibration damper 152 with input 154, output 156 and at least one spring 157 engaged with input 154 and output 156. Output 156 includes output element 112 and is non-rotatably connected to turbine shell 118. In the example of FIG. 1, lock-up clutch 110 includes: drive plate 158 non-rotatably connected to input 154; and friction material 160 axially disposed between cover 104, plate 158, and plate 122. In the clutch apply mode, torque RT is transmitted from cover 104 to output element 112 via drive plate 158, input 154, and output 156.

In the clutch apply mode, fluid F in chamber 150 flows: past friction material 160; through release chamber 148; and into channel CH of transmission input shaft IS. The flow of fluid F is used to cool clutch 110, in particular friction material 160. The rotation of cover 104 in direction CD1 generates coriolis force CF, which urges fluid F, flowing through chamber 148, in direction CD2. Coriolis force CF increases in strength radially inwardly. If not checked, coriolis force CF creates backpressure in chamber 148, which interferes with the radially inward flow of fluid F into channel CH and hampers the operation of clutch 110. For example, the back pressure reduces the fluid pressure differential between chambers 148 and 150, and thus the force clamping clutch 110 closed.

Annular portions 124A and 124B define portion 162 of chamber 148, located radially inward of annular portions 124A and 1248. In the example of FIG. 1, cover 104 is separated from input shaft IS by distance D in direction AD1 in portion 162. Distance D is large enough that known manipulations of the structure of cover 104 do not adequately reduce the coriolis force on fluid F. However, tabs 128, in particular sections 132, rotate through fluid F in direction CD1 to direct fluid F in portion 162 in direction CD1 and counter the effects of coriolis force CF urging fluid F in direction CD2. Thus, the flow of fluid F in portion 162 in direction CD2 due to force CF is minimized and the radially inward flow of fluid F through chamber 148 into channel CH is optimized. As a result, fluid back pressure in chamber 148 is eliminated or reduced to a level which does not interfere with operation of clutch 110.

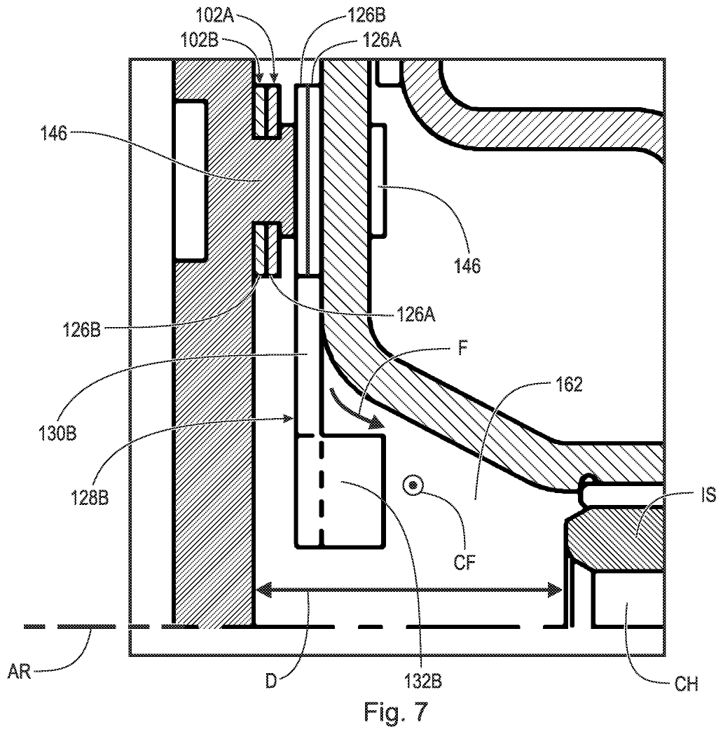

FIG. 7 is a detail of area 6 in FIG. 1 with an example embodiment of coriolis leaf springs 102. Unless noted otherwise, the discussion for FIGS. 1 through 6 is applicable to FIG. 7. In the example of FIG. 6, sections 130B are pinned to cover 104 by fasteners 146. In the example of FIG. 6, the fasteners 146 are extruded rivets formed from cover 104. In the example of FIG. 7, sections 130A are pinned to piston plate 122 by fasteners 146 and sections 132A extend from sections 130A in direction AD1. In the example of FIG. 7, the fasteners 146 pinning sections 130A are extruded rivets formed from piston plate 122. Stated differently, in FIG. 7, springs 102 have been axially flipped from the position shown in FIG. 6.

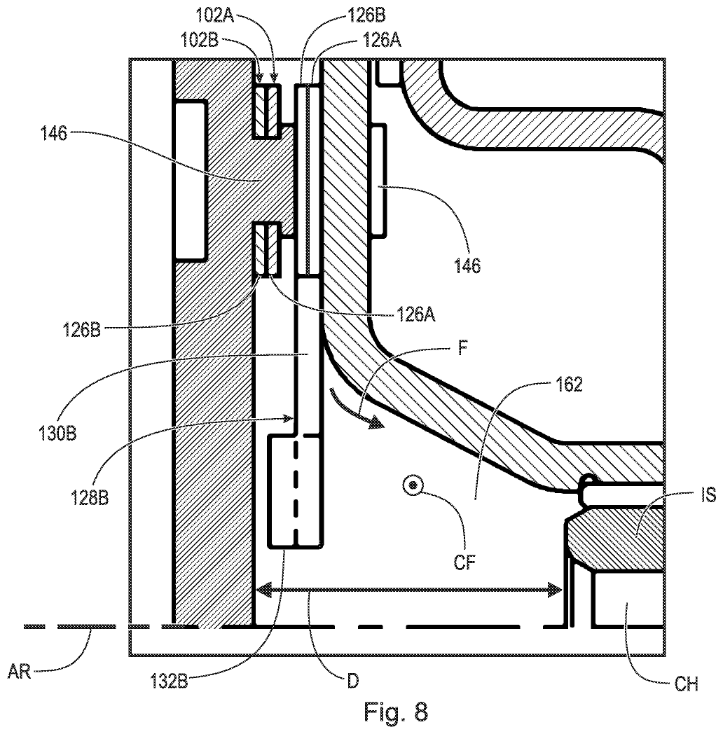

FIG. 8 is a detail of area 6 in FIG. 1 with an example embodiment of coriolis leaf springs 102. Unless noted otherwise, the discussion for FIGS. 1 through 6 is applicable to FIG. 7. In the example of FIG. 8, sections 130A are pinned to piston plate 122 by fasteners 146 and sections 132A extend from sections 130A in direction AD2. In the example of FIG. 8, the fasteners 146 pinning sections 130A are extruded rivets 146 formed from piston plate 122.

The following should be viewed in light of FIGS. 1 through 8. The following describes a method of operating a torque converter 100. Although the method is presented as a sequence of steps for clarity, no order should be inferred from the sequence unless explicitly stated. A first step receives, with cover 104, rotational torque RT in circumferential direction CD1. A second step rotates, with rotational torque RT, cover 104. For a clutch apply mode in which clutch 110 is closed, a third step flows pressurized fluid F from pressure chamber 150 to pressure chamber 148. A fourth step flows pressurized fluid F radially inwardly through pressure chamber 148 to channel CH of transmission input shaft IS. A fifth step generates, with the rotation of cover 104, coriolis force CF on pressurized F in portion 162. A sixth step urges, with coriolis force CF, pressurized fluid F in portion 162 in direction CD2. A seventh step rotates tabs 128 in direction CD1 through pressurized fluid F in portion 162. A seventh step directs, with tabs 128, fluid F in portion 162 in direction CD1.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

AD1 axial direction
AD2 axial direction
AR axis of rotation
CF coriolis force
CH channel
D axial distance
IS transmission input shaft
F fluid
L line
RT rotational torque
100 two-pass torque converter
102 coriolis leaf spring
104 cover
106 impeller
108 turbine
110 lock-up clutch
112 output element
114 impeller shell
116 impeller blade
118 turbine shell
120 turbine blade
122 piston plate
124 ring portion
126 resilient section
128 tab
130 section, tab
132 section, tab
134 surface, tab
136 surface, tab
138 connector
140 circumferential distance
142 circumferential distance
144 opening
146 fastener
148 release pressure chamber
150 apply pressure chamber
152 torsional vibration damper
154 input, damper
156 output, damper
157 spring, damper
158 drive plate
160 friction material
162 portion, release pressure chamber

1. A torque converter, comprising:
a cover arranged to receive rotational torque;
an impeller including:
an impeller shell connected to the cover; and,
at least one impeller blade fixedly connected to the impeller shell;
a turbine including:
a turbine shell; and,
at least one turbine blade fixedly connected to the turbine shell;
a lock-up clutch including a piston plate;
an output element arranged to non-rotatably connect to a transmission input shaft; and,
a leaf spring, formed of a single piece of material, and including:
a ring portion;
a tab extending radially inwardly from the ring portion; and,
a plurality of resilient sections extending from the ring portion and non-rotatably connected to the cover and to the piston plate.

2. The torque converter of claim 1, wherein the ring portion is circumferentially continuous.

3. The torque converter of claim 1, wherein the tab includes:
a first section extending radially inwardly directly from the ring portion; and,
a second section extending in an axial direction, parallel to an axis of rotation of the torque converter, from the first section.

4. The torque converter of claim 3, wherein the axial direction is from the piston plate toward the impeller shell.

5. The torque converter of claim 3, wherein the axial direction is from the impeller shell toward the piston plate.

6. The torque converter of claim 3, wherein the second section includes:
a first surface facing at least partly in a first circumferential direction around an axis of rotation of the torque converter; and,
a second surface facing at least partly in a second circumferential direction, opposite the first circumferential direction.

7. The torque converter of claim 1, wherein a line parallel to an axis of rotation and radially inward of the output element passes through the tab.

8. The torque converter of claim 1, wherein a line parallel to an axis of rotation and radially inward of the piston plate passes through the tab.

9. The torque converter of claim 1, wherein a line parallel to an axis of rotation and radially inward of the turbine shell passes through the tab.

10. The torque converter of claim 1, wherein the leaf spring includes a plurality of connectors:
extending radially outwardly from the ring portion; and,
connecting the plurality of resilient sections to the ring portion.

11. The torque converter of claim 1, wherein the tab includes:
a first section directly connected to the ring portion; and,
a second section:
extending in an axial direction, parallel to an axis of rotation of the torque converter, from the first section; and,
an entirety of which is located radially inward of the impeller.

12. The torque converter of claim 1, wherein:
the cover and the piston plate define at least part of a first pressure chamber;
the cover, the piston plate, and the turbine shell define at least part of a second pressure chamber; and,
the leaf spring is located in the first pressure chamber.

13. A torque converter, comprising:
a cover arranged to receive rotational torque;
an impeller including:
an impeller shell connected to the cover; and,
at least one impeller blade fixedly connected to the impeller shell;
a turbine including:
a turbine shell; and,
at least one turbine blade fixedly connected to the turbine shell;
a lock-up clutch including a piston plate;
an output element arranged to non-rotatably connect to a transmission input shaft; and,
a first leaf spring, formed of a first single piece of material, and including:
a first ring portion;
a first plurality of resilient sections non-rotatably connected to the cover and to the piston plate and located radially outward of the first ring portion; and,
a plurality of first tabs extending radially inwardly from the first ring portion, each first tab including:
a first section directly connected to the first ring portion; and,
a second section extending in an axial direction, parallel to an axis of rotation of the torque converter, from the first section.

14. The torque converter of claim 13, wherein each second section includes a surface facing at least partly in a circumferential direction around the axis of rotation of the torque converter.

15. The torque converter of claim 13, wherein an entirety of each second section is located radially inward of the impeller.

16. The torque converter of claim 13, wherein at least a portion of each second section is located radially inward of the piston plate or of the output element.

17. The torque converter of claim 13, further comprising:
a second leaf spring, formed of a second single piece of material, and including:
a second ring portion;
a second plurality of resilient sections:
non-rotatably connected to the first leaf spring, to the cover, and to the piston plate; and,
located radially outward of the second ring portion; and,
a plurality of second tabs extending radially inwardly from the second ring portion.

18. The torque converter of claim 17, wherein:
each second tab includes:
a first section directly connected to the second ring portion; and,
a second section extending in the axial direction from the first section; and, the second section includes a surface facing at least partly in a circumferential direction.

19. The torque converter of claim 18, wherein the plurality of first tabs and the plurality of second tabs alternate in the circumferential direction.

20. A method of operating a torque converter including a cover, an impeller, a turbine including a turbine shell, a lock-up clutch including a piston plate, and an output element, the method including:
receiving, with the cover, a rotational torque in a first circumferential direction;
rotating, with the rotational torque, the cover, and a leaf spring of the torque converter in the first circumferential direction, the leaf spring formed of a single piece of material and including a ring portion, a plurality of resilient sections located radially outward of the ring portion and non-rotatably connected to the cover and to the piston plate, and a plurality of tabs extending radially inwardly from the ring portion;
for a clutch apply mode in which the lock-up clutch is closed, flowing pressurized fluid from a first pressure chamber formed in part by the cover, the piston plate, and the turbine shell to a second pressure chamber formed in part by the cover and the piston plate;
flowing the pressurized fluid radially inwardly through the second pressure chamber to a channel of a transmission input shaft non-rotatably connected to the output element;
generating, with the rotation of the cover, a coriolis force on the pressurized fluid in a portion of the second pressure chamber defined in part by the ring portion and located radially inwardly of the ring portion;
urging, with the coriolis force, the pressurized fluid in the portion of the second pressure chamber in a second circumferential direction, opposite the first circumferential direction;
rotating the plurality of tabs through the pressurized fluid in the portion of the second pressure chamber; and,
directing, with the plurality of tabs, the pressurized fluid in the second pressure chamber in the first circumferential direction.
